(19) United States
(12) Patent Application Publication
(10) Pub. No.: US 2004/0210933 A1
(43) Pub. Date: Oct. 21, 2004

(54) User interface for a remote control application

(75) Inventors: Mauro Dresti, West Covina, CA (US); Lily Tsong-Chou Knowles, Irvine, CA (US); Cheryl Scott, Newport Beach, CA (US); Wayne Scott, Newport Beach, CA (US)

Correspondence Address: GREENBERG TRAURIG, LLP, 77 WEST WACKER DRIVE, SUITE 2500, CHICAGO, IL, 60601-1732, US

(73) Assignee: Universal Electronics Inc., Cypress, CA (US)

(21) Appl. No.: 10/749,089

(22) Filed: Dec. 30, 2003

Related U.S. Application Data
(60) Provisional application No. 60/438,432, filed on Jan. 7, 2003.

(51) Int. Cl. H04N 5/445; H04N 5/44

(52) U.S. Cl. 725/40; 725/39; 348/734

(57) ABSTRACT

A hand-held electronic device having a remote control application user interface that functions to displays programming related information to a user.

### RELATED APPLICATION

This application claims the benefit of U.S. Provisional Application For Patent Serial No. 60/438,432, filed on Jan. 7, 2003, which is incorporated herein by reference in its entirety.

### BACKGROUND OF THE INVENTION

This invention relates generally to hand-held electronic devices and, more particularly, relates to a user interface for an universal remote control application resident on the hand-held electronic device.

Universal remote controls for controlling the operation of multiple, diverse home appliances are well known. In this regard, universal remote controls perform a valuable function by consolidating three, four, five, and more remote controls into one device. However, as more remotely controllable appliances enter the homes of consumers and the number of remotely controllable operations increase, the user interface of the universal remote control becomes increasingly more complex. This complexity arises from the need to provide more and more keys which are used to initiate the transmission of the control codes that control the increasing number of operations of the increasing number of home appliances. Disadvantageously, as the user interface of the universal remote control becomes more cluttered, the usability of the universal remote control diminishes. Accordingly, a need exists for a universal remote control having an improved user interface that simplifies the operation of the universal remote control and, as such, the remote operation of consumer appliances.

### SUMMARY OF THE INVENTION

In accordance with these needs, the subject invention is directed to a hand-held electronic device having a remote control application user interface that functions to display program related information to a user. Representative platforms for the hand-held electronic device include, but are not limited to, devices such as personal digital assistants, Web tablets, Smart Displays (i.e., devices previously known as “MIRA” type devices), lap-top computers, extended-functionality mobile phones, remote control devices, etc. which are collectively referred to hereinafter as “PDAs.” Such PDA devices are described in U.S. Provisional Patent Application No. 60/344,020, filed on Dec. 20, 2001, and 60/334,774, filed on Nov. 20, 2001, which are incorporated herein by reference in their entirety. An understanding of the objects, advantages, features, properties and relationships of the remote control application user interface will be obtained from the following detailed description and accompanying drawings which set forth illustrative embodiments which are indicative of the various ways in which the principles of the remote control application user interface may be employed.

### BRIEF DESCRIPTION OF THE DRAWINGS

For a better understanding of the remote control application user interface, reference may be had to various preferred embodiments shown in the following drawings in which:

FIG. 1 illustrates an exemplary remote control application residing on a PDA device;

FIG. 2 illustrates an exemplary system and network using a PDA device to effect remote control of consumer entertainment appliances;

FIG. 3 illustrates in block diagram form exemplary components of the PDA device of FIGS. 1 and 2;

FIGS. 4 through 6 illustrate exemplary methods of accessing remotely located data for use in the exemplary PDA device;

FIG. 7 illustrates an exemplary screen shot of a remote control application user interface having a favorites page; and

FIG. 8 illustrates an exemplary screen shot of the remote control application user interface of FIG. 7 further displaying program related information windows.

### DETAILED DESCRIPTION

Exemplary embodiments of an user interface for an universal remote control application resident on a PDA device are illustrated and described. It will be appreciated by those of ordinary skill in the art that the teachings that follow can be easily adapted to intended target platforms and software systems, for example, by making simple adjustments to display graphic sizes and layouts, file formats, etc., as needed.

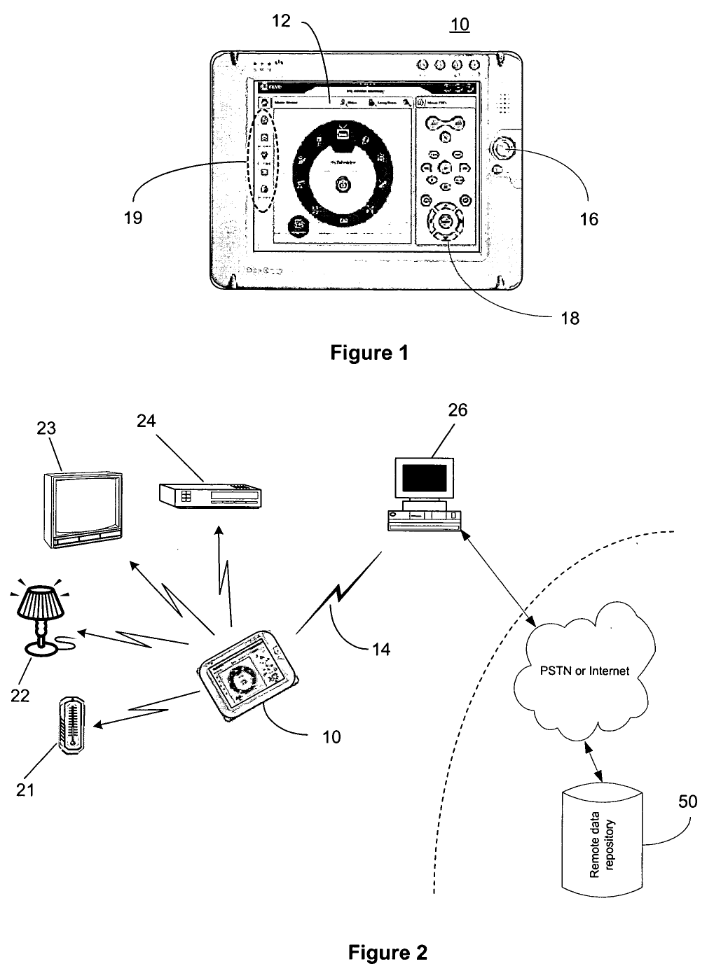

Referring now to FIGS. 1 and 2, generally, the PDA device 10 that hosts the universal remote control application is adapted to provide wireless control of consumer appliances such as home entertainment equipment 23, 24, lighting 22, temperature control 21, etc., via a graphical user interface presented on an LCD display panel 12. In response to user interaction with hard keys 16 and/or a touch sensitive panel 18 overlayed on LCD display 12, control signals are provided, for example, by causing the PDA device to emulate the wireless signals (IR, RF, etc.) used by the standard remote controls originally supplied with the respective appliances. The PDA device 10 is also preferably adapted to interact with Web-hosted services 50, for example, to receive IR code updates, graphics, software enhancements, electronic program guides (EPGs), etc. Interaction may be indirectly via a host desktop computer 26 either wirelessly 14 or via a docking station as will be described in more detail hereafter. It will be appreciated by those skilled in the art that the Web-hosted services may also be accessed directly, sans an intervening host desktop computer 26, in cases where the PDA device 10 is adapted to communicate directly to a network, such as the Internet. The PDA device 10 may be setup to control the operation of appliances using any well known setup procedure, e.g., step and set, direct entry, etc.

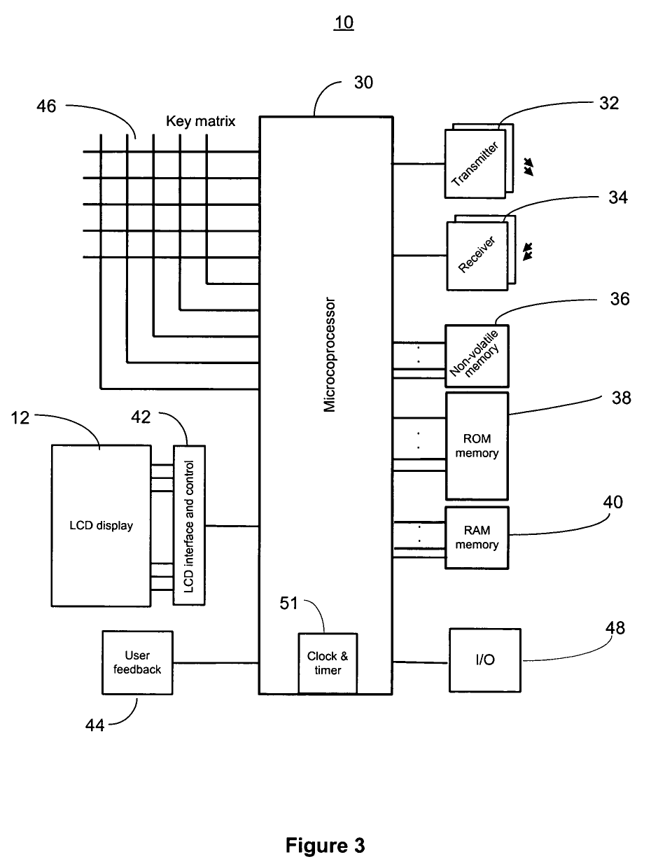

By way of more specific example and with reference to FIG. 3, the underlying PDA device platform may include a processor 30 coupled to a memory system comprising one or more of ROM memory 38, non-volatile read/write memory 36, and RAM memory 40; an LCD display 12 interfaced via LCD interface and control electronics 42, a key matrix 46 which may include both hard keys and a touch sensitive (“soft key”) surface overlayed on LCD display 12, other input means as required by a particular application (e.g., mouse, “graffiti” handwriting input pad, joystick, or other user input device—not illustrated); an internal clock and timer 51; wireless transmitter 32 and receiver 34 circuit(s)- or transceiver circuit(s) (e.g. infrared, Bluetooth, WiFi, etc.) as required to allow the device to exchange communications with the appliances to be controlled and/or computer 26 or an intermediate gateway; a power supply—not illustrated; additional means 44 to provide visible, audible or haptic feedback; and I/O circuitry 48 for communicating with a docking station. As noted previously, representative platforms include, but are not limited to, devices such as remote controls, lap-top computers, Web Tablets and/or PDAs manufactured by Compaq, HP, Palm, Visor, etc.

The memory system includes executable instructions that are intended to be executed by the processor to control the operation of the platform. In this manner, the processor may be programmed to control the various electronic components within the device, e.g., to monitor power, to cause the transmission of signals, etc. Within the memory system, the ROM portion of memory 38 may be used to store fixed programming and data that remains unchanged for the life of the product. The non-volatile read/write memory 36, which may be FLASH, EEPROM, battery-backed up RAM, “Smart Card,” memory stick, or the like, may be provided to store, additional programming, consumer entered data and setup parameters, downloaded data, etc., as necessary. RAM memory 40 may be used by the processor for working storage as well as to hold data items which, by virtue of being backed up or duplicated on an external computer are not required to survive loss of battery power. While the memory system is described as comprising all three classes of memory, it will be appreciated that, in general, such a memory system need not necessarily support all three, and can be comprised of any type of computer-readable media, such as ROM, RAM, SRAM, FLASH, EEPROM, or the like in combination. Preferably, however, at least part of the memory system should be non-volatile or battery backed such that basic setup parameters and operating features will survive loss of battery power. In addition, such memories may take the form of a chip, a hard disk, a magnetic disk, and/or an optical disk without limitation.

For commanding the operation of appliances of different makes, models, and types, the memory system may include a command code library. The command code library is comprised of a plurality of command codes that may be transmitted from the platform for the purpose of controlling the operation of an appliance. The memory system may also include instructions which the processor uses in connection with a transmission circuit 32 to cause the command codes to be transmitted in a format recognized by an identified appliance. While the transmission circuit 32 preferably utilizes infrared transmissions, it will be appreciated that other forms of wired or wireless transmissions, such as radio frequency, may also be used.

To cause the platform to perform an operation, the platform is adapted to be responsive to events, such as a sensed interaction with one or more keys on the key matrix (hard and/or soft keys) or a signal from an external source such as, for example, the remote computer 26. More specifically, in response to an event, appropriate instructions within the memory system are executed. For example, when a hard or soft command key is activated on the platform, the platform may read the command code corresponding to the activated command key from the memory system and transmit the command code to an appliance in a format recognizable by the appliance. It will be appreciated that the instructions within the memory system can be used not only to cause the transmission of command codes to appliances but also to perform local operations. While not limiting, local operations that may be performed by the device include favorite channel setup, macro button setup, command function key relocation, etc.

As discussed, the platform comprises a general purpose, processor system which is controllable by software. The software may include routines, programs, objects, components, and/or data structures that perform particular tasks that can be viewed as an operating system together with one or more applications. The operating system, such as the “Windows CE” or “Windows XP” brand operating system or the like, provides an underlying set of management and control functions which are utilized by applications to offer consumer functions such as calendar, address book, spreadsheet, notepad, etc., as well as control of appliances. Additional applications can be provided for use in accessing Internet data, displaying TV guide information, and the like. Thus, it should be understood that, in terms of the internal software architecture, a “remote control” application may be but one of several possible applications which may co-exist within the platform. It should also be understood that in terms of providing operating system functionality, the demarcation between a platform and a host/client PC may vary considerably from product to product—at one extreme the platform may be nothing more than a slave display and input device in wireless communication with a PC that performs all computational functions and, at the other extreme, the platform may be a fully-functional PC system in its own right complete with local mass storage. It will also be appreciated that in an alternative embodiment, a similar hardware platform to that described above may be used in conjunction with a scaled-down operating system to provide remote control functionality only, i.e., as a standalone application. In all cases, however, the principles expressed herein remain the same.

To provide a means by which a consumer can interact with the platform, the platform is provided with software that implements a graphical user interface. A detailed description of such a graphical user interface system, together with methods by which a user may identify appliances by type and make (and sometimes model) such that the platform is adapted to transmit recognizable command codes in the format appropriate for such identified appliances, as well as methods by which a user may program local operations to be performed can be found in pending U.S. Application 60/264,767, Ser. No. 10/290,605 and 10/288,727 all of like assignee and all incorporated herein by reference in their entirety.

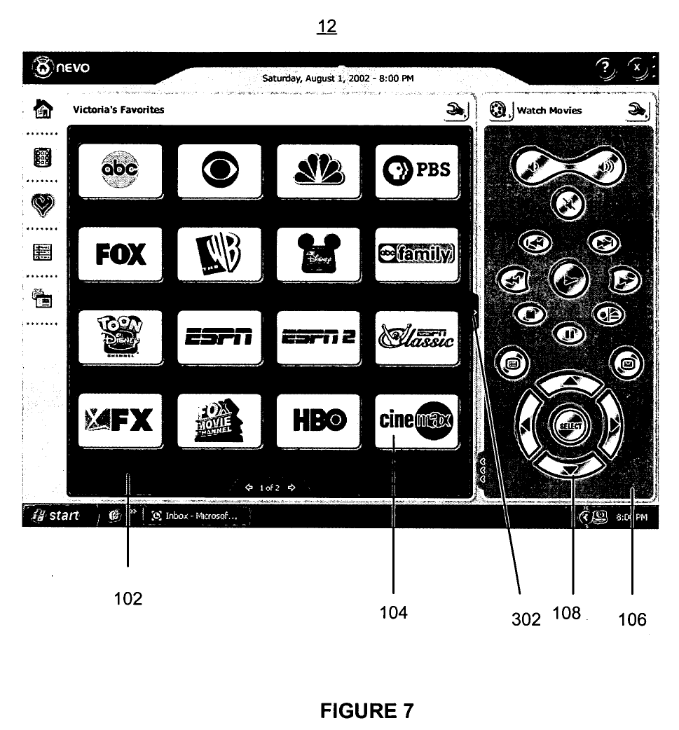

For use in commanding the operation of home appliances and, as will be described hereinafter, to access program related information, the remote control application provides a user interface that is illustrated by way of example in FIGS. 1 and 7. Within a primary (or “home”) user interface, illustrated by way of example in FIG. 1, icons 19 may be provided to allow the user to select various alternative interfaces and modes of operation such as, for example, a control surface (i.e., a GUI page) corresponding to a specific appliance, a TV guide display, etc. Of particular interest, a favorites page 102 may be provided, an example of which is illustrated in FIG. 7.

The favorites page 102 may be setup by the user so as to associate an icon 104, for example representative of a logo of a content provider, with a command to tune an appliance, such as television, satellite or cable set top box, VCR, or the like, to a particular channel. Preferably the channel would be associated, in this case, with the content provider represented by the icon. In this manner, as described in the previously referenced U.S. application Ser. No. 10/288,727, activation of an icon 104 may be used to cause the PDA device 10 to transmit the associated command to an intended target appliance to effect a channel tuning operation. The user interface may additionally provide a command key area 106 which provides icons 108 representative of conventional remote control function keys. Again, these icons 108 may be setup by a user, using well known methods, such that activation of an icon 108 would result in the PDA device 10 transmitting a command to an intended target appliances to control the operation of the intended target appliance.

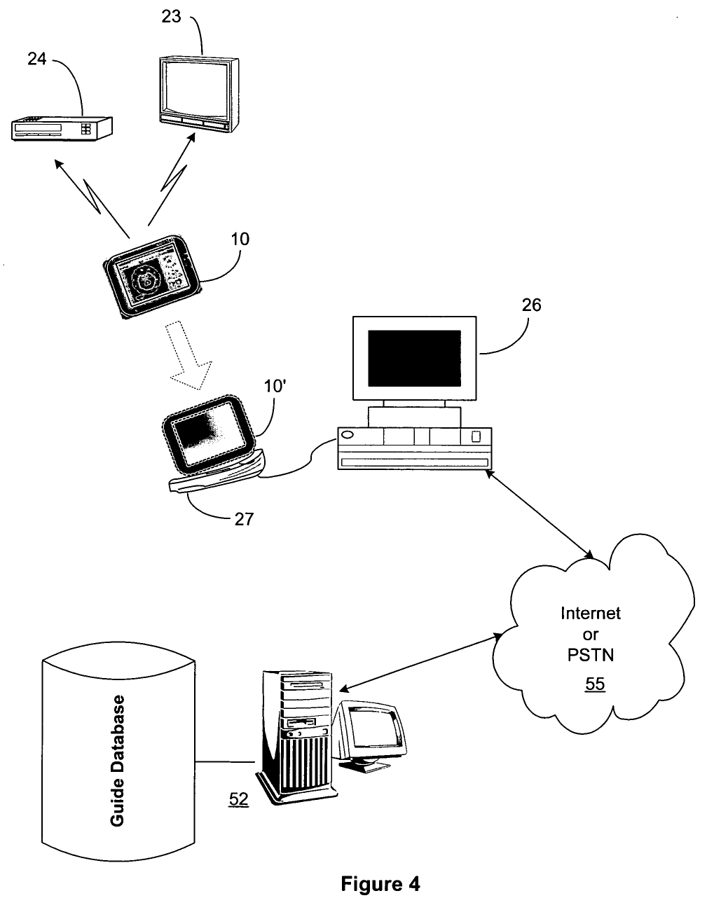

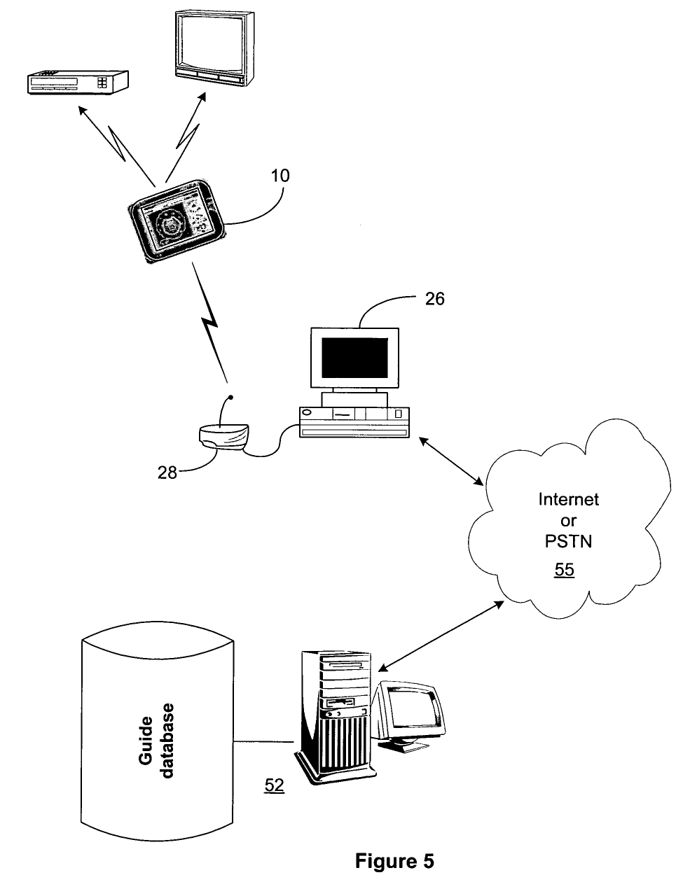

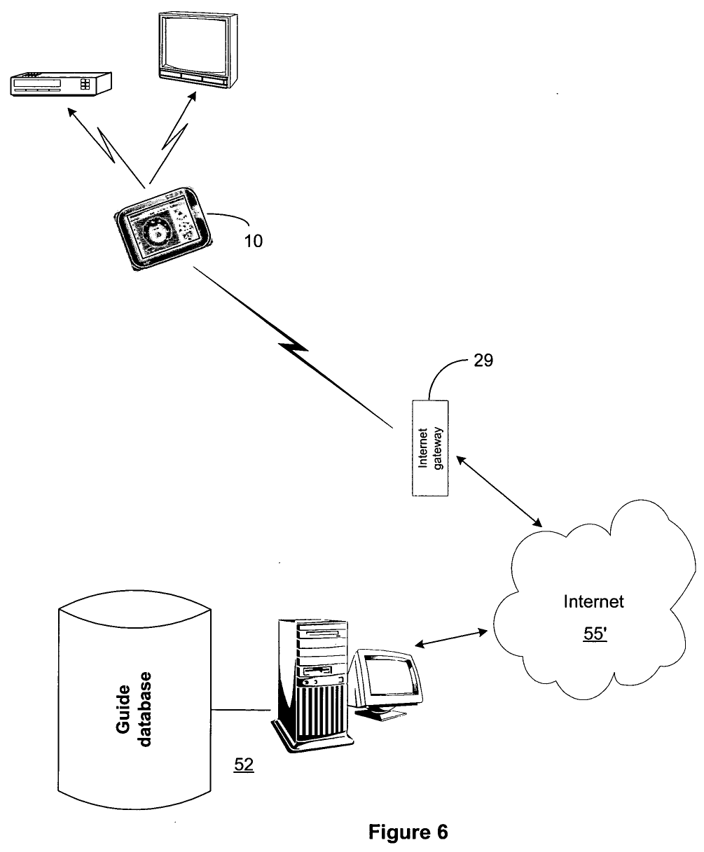

As illustrated in FIGS. 4, 5, and 6, the PDA device 10 may be adapted to receive and store television guide (e.g., program lineups for one or more content providers) and/or programming description information from a remote server 52 via a network 55, e.g., the Internet, a PSTN network, or the like. The television guide and/or programming description information may be transferred to the PDA device 10 via a docking station 27 and intermediate PC 26, as illustrated in FIG. 4; via wireless communication with a base station 28 (e.g., using WiFi, Bluetooth, etc.) connected to an intermediate PC 26, as illustrated in FIG. 5; via direct wireless communication with an Internet gateway device 29, as illustrated in FIG. 6; etc. For further background on the provisioning and use of television guide and/or programming description information in PDA devices 10, the reader is directed to co-pending U.S. application Ser. Nos. 10/287,337 and 10/287,389, both of which are incorporated herein by reference in their entirety.

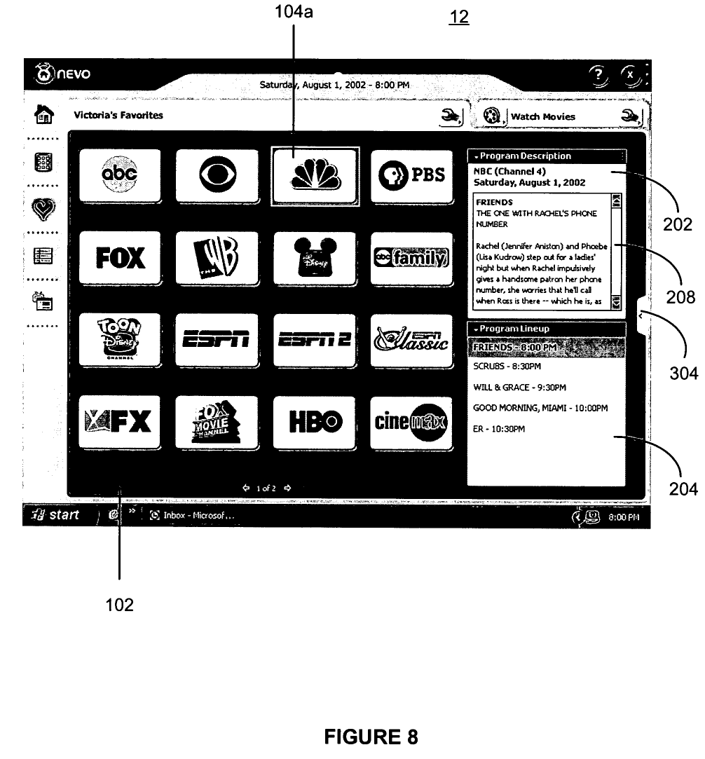

For use in displaying obtained television guide and/or programming information, the user interface of the PDA device 10 may be adapted such that activation of an icon 104 in the favorites area 102 may also instantiate a window area 202, illustrated by way of example in FIG. 8, that presents information relevant to the content provider associated with the channel the intended target device is to be tuned to. In the illustrated example, in the event that the user activates the icon 104a, which depicts the logo for the “NBC” network, the PDA device would transmit a command to tune an intended target appliance to a channel that carries the “NBC” network broadcast content while simultaneously causing the window area 202 to be instantiated so as to display information relevant to the content presently being broadcast by the “NBC” network, e.g., programming description information. Activation of an icon 104 may also be used to instantiate a window area 204 that presents television guide information relevant to programs of the content provider, e.g., content currently being broadcast, past broadcasts, and/or future broadcasts. Both windows may be displayed simultaneously, as illustrated in FIG. 8; alternatively either one may comprise the sole display supported by a particular embodiment. It will be further appreciated that, in some instances, it may be desirable to instantiate the window areas 202 and/or 204 without causing the PDA device to transmit tuning commands so as to allow for content browsing. To this end, a control icon may be made available to allow the user to turn on and off the transmitting capabilities of the PDA device as it pertains to this feature.

For allowing alternating access to the function key icons 108 and window areas 202 and/or 204, the user interface may provide controls 302 and 304 that are activated to expand and collapse, respectively, the favorites area 102. In such an embodiment, the window areas 202 and/or 204 would be associated with the favorites area 102 and would, as such, overlay the function key area 106 when instantiated. It will be appreciated that the window areas 202 and/or 204 can also be implemented as self contained windows and expanded and collapsed using conventional windowing user interface technologies. Such conventional windowing user interface technologies may also be used to allow a user to scroll information displayed in window areas 202 and/or 204 (e.g., by using a scroll bar 208), to expand/contract the window areas, change the relative size of the window areas, etc.

As noted previously, information to be displayed in the window areas 202 and/or 204 may be loaded into the PDA device directly, for example, via a direct link with the Internet, or indirectly via a PC, link with a cable set top box, a gateway device, etc. Furthermore, the information may be preloaded into the PDA device or downloaded on demand in near real-time as required. Accordingly, while specific embodiments have been described in detail, it will be appreciated by those skilled in the art that various modifications and alternatives to those details could be developed in light of the overall teachings of the disclosure. For example, while described in the context of functional modules and illustrated using block diagram format, it is to be understood that, unless otherwise stated to the contrary, one or more of the described functions and/or features may be integrated in a single physical device and/or a software module in a software product, or one or more functions and/or features may be implemented in separate physical devices or software modules. It will also be appreciated that a detailed discussion of the actual implementation of each module is not necessary for an enabling understanding of the invention. Rather, the actual implementation of such modules would be well within the routine skill of a programmer and system engineer, given the disclosure herein of the system attributes, functionality, and inter-relationship of the various functional modules in the system. Thus, the particular arrangement disclosed is meant to be illustrative only and not limiting as to the scope of the invention which is to be given the full breadth of the appended claims and any equivalents thereof.

What is claimed is:

1. A method for displaying programming information using a remote control device, comprising:
accepting user input for creating a favorites page having a plurality of icons each of which is assigned a command code to be transmitted by the remote control device to tune an intended target appliance to a channel;
accepting user input selecting one of the icons from a display of the favorites page; and
in response to the user selecting an icon, displaying in a first window area information relevant to content available from a provider of content on the channel associated with the selected icon.

2. The method as recited in claim 1, wherein the information displayed in the first window is relevant to content currently being presented by the provider of content on the channel associated with the selected icon.

3. The method as recited in claim 1, wherein the information displayed in the first window is relevant to content to be presented in the future by the provider of content on the channel associated with the selected icon.

4. The method as recited in claim 2, further comprising displaying in a second window, in response to the user selecting the icon, information relevant to content to be presented in the future by the provider of content on the channel associated with the selected icon.

5. The method as recited in each of claims 1-4, further comprising causing, in response to the user selecting the icon, the remote control device to transmit the command to tune the intended target appliance to the channel associated with the selected icon.

6. The method as recited in claim 4, wherein the first window area and the second window area are associated with a favorites page.

7. The method as recited in each of claims 1-3, further comprising accepting user input for expanding and contracting the first window area.

8. The method as recited in claim 7, in which the expansion and contraction of the first window area allows overlay and display, respectively, of a user interface page having command function keys.

9. The method as recited in claim 4, further comprising accepting user input for expanding and contracting the first and second window areas.

10. The method as recited in claim 9, in which the expansion and contraction of the first and second window areas allows overlay and display, respectively, of a user interface page having command function keys.
